(19) United States
(12) Patent Application Publication
(10) Pub. No.: US 2014/0022238 A1
(43) Pub. Date: Jan. 23, 2014

(54) SYSTEM FOR SIMULATING USER CLOTHING ON AN AVATAR

(71) Applicant: SeungWoo Oh, Koyang (KR)

(72) Inventor: SeungWoo Oh, Koyang (KR)

(73) Assignee: CLO VIRTUAL FASHION INC., Seoul (KR)

(21) Appl. No.: 13/553,900

(22) Filed: Jul. 20, 2012

(51) Int. Cl. G06T 19/20

(52) U.S. Cl. 345/419

(57) ABSTRACT

Embodiments of the present invention provide an approach for providing a clothing system for simulating user clothing on a virtual avatar. Specifically, in a typical embodiment, an avatar may be associated with the user. A unified clothing file stores any number of actual clothing items and associated virtual clothing items. Each actual clothing item and associated virtual clothing item is encoded with the same identification code. The user may select a virtual clothing item to be worn by the user's avatar by entering a unique identification code. Using the unique identification code, a unified clothing file entry is retrieved from the unified clothing file. An image is generated of the avatar wearing the virtual clothing item.

### TECHNICAL FIELD

In general, embodiments of the present invention provide an approach for simulating clothing. Specifically, embodiments of the present invention relate to an approach for providing a clothing system for simulating user clothing on a virtual avatar.

### BACKGROUND

A virtual world is an online community that takes the form of a computer-based simulated environment through which users can interact with one another and use and create objects. Online, Internet accessible virtual worlds have become increasingly popular, as personal computers have grown in power and become widely affordable, and high-speed Internet access has become commonplace. The term “virtual world” has become largely synonymous with interactive three-dimensional (3D) virtual environments, where the users take the form of avatars visible to others.

In many virtual worlds, the avatars are able to mimic the actions of real people in many ways, such as by looking in different directions, moving to different locations, entering buildings, handling objects, and even interacting with other avatars. Interactions between avatars can include speaking, showing facial expressions, and using movements to display a range of feelings and emotions, for example, by drooping over to indicate illness, shedding tears to show sadness, or jumping around to show joy or excitement. Generally, an avatar functions as an extension of its user by going where the user directs, looking where the user wishes to look, and expressing emotions which reflect the emotions of the user. Typically, users are able to customize body shape, gender, facial features, hair style, and clothing. In some instances, a user may purchase one or more clothing items for an avatar from an avatar marketplace.

Similarly, a person may purchase one or more clothing items for himself/herself using an online marketplace. Convenience is a great advantage to online shopping. Shopping online is generally quite easy. A person can simply sit in front of the computer and click around, from one site to another. Also, online clothes shopping may provide the chance to browse for diverse items in different stores at the same time, with a wide range of clothing choices to select from.

However, there is no clothing system for simulating user clothing on a virtual avatar. Heretofore, several unsuccessful attempts have been made to address these shortcomings.

U.S. Pat. No. 7,808,385 discloses an interactive clothing system which allows a user to interact with an article of clothing.

U.S. Patent Application 20080262944 discloses an online clothing display system including a dressed mannequin, a rotating platform, an image recorder, and a mainframe.

U.S. Patent Application 20090260123 discloses a clothing system having a plurality of different clothing articles that are designed to be used with interactive decorative elements.

U.S. Pat. No. 7,742,901 discloses a method and system for analyzing and/or generating object models, and, in particular, to generating object models of a second type using object models of the first type.

U.S. Patent Application 20070273711 discloses a unique 3D graphics system and method that allows participants to change their avatar's clothes by constructing a new avatar consisting of multiple models including the basic nude model and all of its parts, all the clothing models, hair models, and any other models that might be required.

U.S. Patent Application 20050137015 discloses a system and method that allows for a role-playing game having a customizable avatar and differentiated instant message environment.

None of these references, however, teach a clothing system for simulating user clothing on a virtual avatar.

### SUMMARY

Embodiments of the present invention provide an approach for providing a clothing system for simulating user clothing on a virtual avatar. Specifically, in a typical embodiment, an avatar may be associated with the user. A unified clothing file stores any number of actual clothing items and associated virtual clothing items. Each actual clothing item and associated virtual clothing item is encoded with the same identification code. The user may select a virtual clothing item to be worn by the user's avatar by entering a unique identification code. Using the unique identification code, a unified clothing file entry is retrieved from the unified clothing file. An image is generated of the avatar wearing the virtual clothing item.

As used herein, the unified clothing file may be of any suitable format including XML documents, flat files, CSV files, SQL tables, relational database tables, and others. The unified clothing file entry may be any suitable entry in the unified clothing file.

A first aspect of the present invention provides a method for simulating user clothing on a virtual avatar, comprising: receiving an identification code; retrieving a virtual clothing item using the identification code; and generating an image of the virtual avatar wearing the virtual clothing item.

A second aspect of the present invention provides a system for simulating user clothing on a virtual avatar, comprising: a memory medium comprising instructions; a bus coupled to the memory medium; and a clothing simulation tool coupled to the bus that when executing the instructions causes the system to: receive an identification code; retrieve a virtual clothing item using the identification code; and generate an image of the virtual avatar wearing the virtual clothing item.

A third aspect of the present invention provides a computer program product for simulating user clothing on a virtual avatar, the computer program product comprising a computer readable storage medium, and program instructions stored on the computer readable storage medium, to: receive an identification code; retrieve a virtual clothing item using the identification code; and generate an image of the virtual avatar wearing the virtual clothing item.

A fourth aspect of the present invention provides a method for deploying a system for simulating user clothing on a virtual avatar, comprising: providing a computer infrastructure being operable to: receive an identification code; retrieve a virtual clothing item using the identification code; and generate an image of the virtual avatar wearing the virtual clothing item.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a computerized implementation of the present invention according to an embodiment of the present invention.

FIG. 2 shows a more detailed view of an example clothing simulation tool according to an embodiment of the present invention.

FIG. 3 shows an image of the virtual fitting of an avatar according to an embodiment of the present invention.

FIG. 4 shows a method flow diagram for simulating user clothing on a virtual avatar according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

Embodiments of the present invention provide an approach for providing a clothing system for simulating user clothing on a virtual avatar. Specifically, in a typical embodiment, an avatar may be associated with the user. A unified clothing file stores any number of actual clothing items and associated virtual clothing items. Each actual clothing item and associated virtual clothing item is encoded with the same identification code. The user may select a virtual clothing item to be worn by the user's avatar by entering a unique identification code. Using the unique identification code, a unified clothing file entry is retrieved from the unified clothing file. An image is generated of the avatar wearing the virtual clothing item.

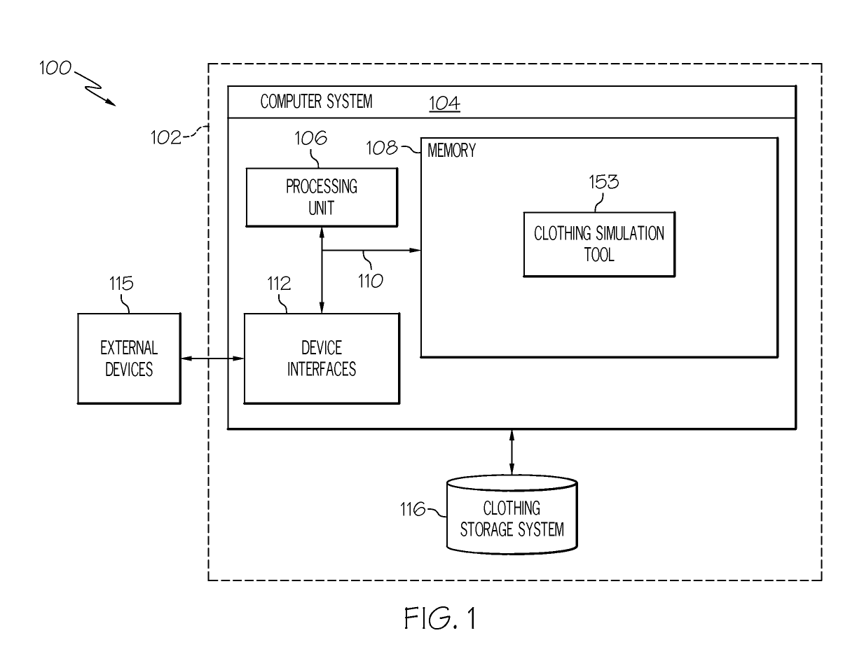

FIG. 1 illustrates a computerized implementation 100 of the present invention. As depicted, implementation 100 includes computer system 104 deployed within a computer infrastructure 102. This is intended to demonstrate, among other things, that the present invention could be implemented within a network computing environment (e.g., the Internet, a wide area network (WAN), a local area network (LAN), a virtual private network (VPN), etc.), or on a stand-alone computer system. In the case of the former, communication throughout the network can occur via any combination of various types of communication links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 102 is intended to demonstrate that some or all of the components of implementation 100 could be deployed, managed, serviced, etc., by a service provider who offers to implement, deploy, and/or perform the functions of the present invention for others.

Computer system 104 is intended to represent any type of computer system that may be implemented in deploying/realizing the teachings recited herein. In this particular example, computer system 104 represents an illustrative system for creating a unified clothing file. It should be understood that any other computers implemented under the present invention may have different components/software, but will perform similar functions. As shown, computer system 104 includes a processing unit 106, memory 108 for storing, a clothing simulation tool 153, a bus 110, and device interfaces 112.

Processing unit 106 collects and routes signals representing outputs from external devices 115 (e.g., a keyboard, a pointing device, a display, a graphical user interface, etc.) to clothing simulation tool 153. The signals can be transmitted over a LAN and/or a WAN (e.g., T1, T3, 56 kb, X.25), broadband connections (ISDN, Frame Relay, ATM), wireless links (802.11, Bluetooth, etc.), and so on. In some embodiments, the signals may be encrypted using, for example, trusted key-pair encryption. Different external devices may transmit information using different communication pathways, such as Ethernet or wireless networks, direct serial or parallel connections, USB, Firewire®, Bluetooth®, or other proprietary interfaces. (Firewire is a registered trademark of Apple Computer, Inc. Bluetooth is a registered trademark of Bluetooth Special Interest Group (SIG)).

In general, processing unit 106 executes computer program code, such as program code for operating clothing simulation tool 153, which is stored in memory 108 and/or clothing storage system 116. While executing computer program code, processing unit 106 can read and/or write data to/from memory 108. Clothing storage system 116 can include VCRs, DVRs, RAID arrays, USB hard drives, optical disk recorders, flash storage devices, or any other similar storage device. Although not shown, computer system 104 could also include I/O interfaces that communicate with one or more external devices 115 that enable a user to interact with computer system 104.

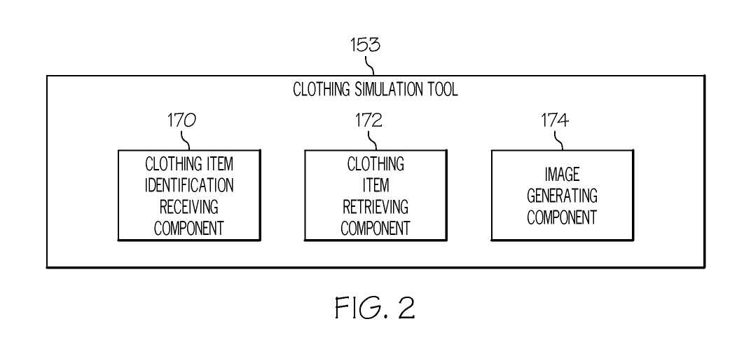

FIG. 2 illustrates a more detailed view of an example clothing simulation tool 153. Clothing simulation tool 153 includes a clothing item identification receiving component 170, clothing item retrieving component 172, and image generating component 174.

The clothing item identification receiving component 170 may receive an identification code from a user. The clothing item retrieving component 172 retrieves a virtual clothing item from a unified clothing file. In one example, the virtual clothing item is associated with an actual clothing item selected by the user. The image generating component 174 displays an image of the virtual clothing item on the avatar.

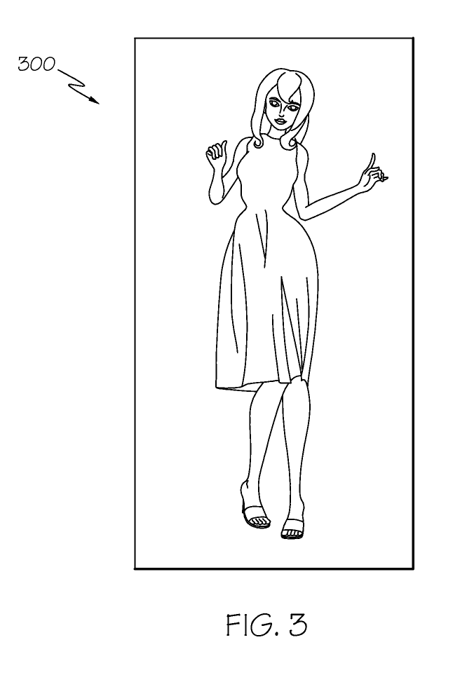

FIG. 3 illustrates an image 300 of the virtual fitting of an avatar according to an embodiment of the present invention. The image of the avatar wearing the virtual clothing item simulates the user wearing the actual clothing item. The generated image may be a still image, a series of still images, or a video. The still image may be a two-dimensional or three-dimensional image. In one example, the generated image may be pushed to a computing device (e.g., a smart phone) of the user.

As used herein, “computing device” refers to a computer system that is operable to execute an OS and software applications, and to store user data. Examples of computing devices include, but are not limited to, desktop computers, laptop computers, and mobile computing devices such as personal digital assistants (PDAs) and smart phones. In one example, a mobile computing device may include multiple device components. Device components may include any component connected to or in communication with a mobile computing device. Examples of device components include, but are not limited to, keypads, keyboards, thumbboards, displays, motors, wireless radios, I/O interfaces and NV devices such as cameras, speakers and microphones. A mobile computing device may further comprise a processor operative to generate a control signal for one or more of the device components. The processor may be any suitable type of general purpose or host processor. Another example of a computing device is a virtual machine which executes an OS and applications just like any other hardware, except the hardware is emulated with software. It is noted that the techniques for desktop management and delivery described herein are not limited to being implemented for any particular type of computing device; rather the techniques described herein may be implemented on any computing device that is operable to execute an OS and software applications and to store user data. For this reason, the examples of computing devices provided herein are to be regarded in an illustrative rather than a restrictive sense.

The term “operating system” (or “OS”) is used herein in its commonly accepted meaning and refers to a software component that is responsible for the allocation, management, coordination, and sharing of computer system resources that are used by other applications or components of a computing device. Examples of such computing resources include, without limitation, Central Processing Units (CPUs or processors), memory, disk storage space, network communication interfaces, and various peripheral devices such as a video display (e.g., a monitor), a pointing device (e.g., a mouse), and a keyboard. When executed on a computing device, an OS controls the operation of the computer system hardware and provides a number of services to user(s) of the computing device and to software applications that execute on the computing device. Examples of such services include, without limitation, file system services that allow for storing and maintaining files on storage devices, memory management services that allocate and manage dynamic memory for software applications, network management services that provide for network access, user interface services (e.g., shells, command line interfaces, and graphical user interfaces) that allow users to submit commands directly to the OS, user logon, and other user-related security services, and a number of other services that provide various functionalities to the software applications that may execute on a computing device. Typically, a software application is operable to request a service from the OS by making a system call or by executing an OS command, and to receive the results of the service call or OS command.

Like people, avatars may be created in various shapes, sizes, skin tones, and the like. Typically, the avatar is the graphical representation of the user or the user's alter ego or character. The avatar may take either a three-dimensional form or a two-dimensional form. In one example, the avatar may be a three-dimensional graphical representation of the user.

A unified clothing file may be generated from a selection of actual clothing items and virtual clothing items. A unified clothing file entry may include an actual clothing item and similar virtual clothing item. In one example, the virtual clothing item may be associated with an avatar. In a second example, the clothing item (e.g., handbag or hat) may not be associated with a specific avatar. Any number of actual clothing items and virtual clothing items may be stored in the unified clothing file. A clothing item may include any object having pattern and/or sewing data, such as shirts, pants, coats, jackets, dresses, skirts, handbags, purses, hats, footwear, accessories, and the like. In one example, a design feature may be used to design a clothing item. In other examples, the user may select from pre-defined clothing items. In one example, the avatar clothing items may be tailored to the physical appearance of the avatar (shape, size, etc.). The actual clothing item and the virtual clothing item may be assigned a unique identification code. The unified clothing file entry is stored with the identification code to allow for retrieval of the clothing items.

In one example, the identification code may be a two-dimensional barcode that includes at least one of a PDF417 code, an Aztec code, a quick response (QR) code, a codablock code, a code 1, a code 16K, a code 49, a CP code, a data glyph code, a datastrip code, a dot code A, a maxicode code, a minicode code, a smartcode code, a supercode code, a snowflake code, an ultracode code, a paperdisk code, or a reduced space symbology code. In a second example, the identification code may be a serial number, such as a serial number that represents a specific clothing item from a specific brand. In a third example, the identification code may be a watermark. In other examples, the identification code may be another code or value.

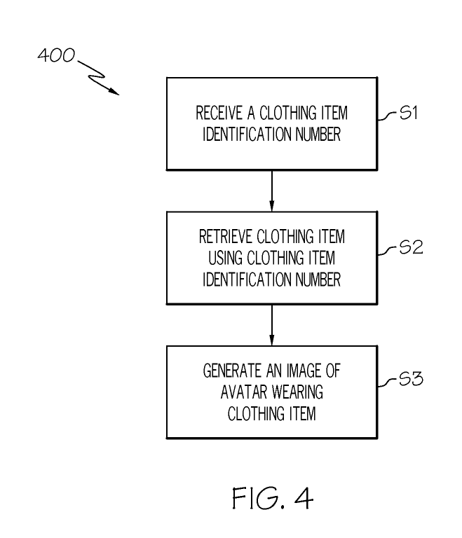

FIG. 4 illustrates a method flow diagram for simulating user clothing on a virtual avatar according to an embodiment of the present invention. The user may wish to view the avatar wearing a certain clothing item to get an idea of how the actual clothing item associated with the virtual clothing item will look when worn by the user. To that end, the user supplies the identification code of the clothing item for the virtual fitting at S1. Using the identification code, the clothing item is retrieved from the clothing file at S2. An image is generated of the avatar wearing the clothing item at S3.

The systems and methods described herein are not limited to a virtual clothing environment. The concepts may be applied to house remodeling automobile remodeling, and similar applications.

It should be noted that, in some alternative implementations, the functions noted in the blocks may occur out of the order noted in FIG. 4. For example, two blocks shown in succession may, in fact, be executed substantially concurrently. It will also be noted that each block of flowchart illustration can be implemented by special purpose hardware-based systems that perform the specified functions or acts, or combinations of special purpose hardware and computer instructions.

Further, it can be appreciated that the methodologies disclosed herein can be used within a computer system to provide a virtual fitting service, as shown in FIG. 1. In this case, clothing simulation tool 153 can be provided, and one or more systems for performing the processes described in the invention can be obtained and deployed to computer infrastructure 102. To this extent, the deployment can comprise one or more of (1) installing program code on a computing device, such as a computer system, from a computer-readable medium; (2) adding one or more computing devices to the infrastructure; and (3) incorporating and/or modifying one or more existing systems of the infrastructure to enable the infrastructure to perform the process actions of the invention.

The exemplary computer system 104 may be described in the general context of computer-executable instructions, such as program modules, being executed by a computer. Generally, program modules include routines, programs, people, components, logic, data structures, and so on, that perform particular tasks or implement particular abstract data types. Exemplary computer system 104 may be practiced in distributed computing environments where tasks are performed by remote processing devices that are linked through a communications network. In a distributed computing environment, program modules may be located in both local and remote computer storage medium including memory storage devices.

Furthermore, an implementation of exemplary computer system 104 may be stored on or transmitted across some form of computer readable media. Computer readable media can be any available media that can be accessed by a computer. By way of example, and not limitation, computer readable media may comprise “computer storage medium” and “communications media.”

“Computer storage medium” include volatile and non-volatile, removable and non-removable media implemented in any method or technology for storage of information such as computer readable instructions, data structures, program modules, or other data. Computer storage medium includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

It is apparent that there has been provided with this invention an approach for simulating a virtual fitting of an avatar. While the invention has been particularly shown and described in conjunction with a preferred embodiment thereof, it will be appreciated that variations and modifications will occur to those skilled in the art. Therefore, it is to be understood that the appended claims are intended to cover all such modifications and changes that fall within the true spirit of the invention.

What is claimed is:

1. A computer-implemented method for simulating user clothing on a virtual avatar, comprising:
receiving an identification code;
retrieving a virtual clothing item using the identification code; and
generating an image of the virtual avatar wearing the virtual clothing item.

2. The computer-implemented method of claim 1, wherein the virtual clothing item is associated with an actual clothing item.

3. The computer-implemented method of claim 1, wherein the identification code comprises one of a two-dimensional barcode, watermark, or serial number.

4. The computer-implemented method of claim 1, wherein the image comprises one of a still image, a series of still images, or a video.

5. The computer-implemented method of claim 1, wherein the image is transmitted to a computing device.

6. The computer-implemented method of claim 5, wherein the computing device is a smart phone.

7. The computer-implemented method of claim 1, wherein the virtual avatar is associated with a user.

8. A system for simulating user clothing on a virtual avatar, comprising:
a memory medium comprising instructions;
a bus coupled to the memory medium; and
a clothing simulation tool coupled to the bus that when executing the instructions causes the system to:
receive an identification code;
retrieve a virtual clothing item using the identification code; and
generate an image of the virtual avatar wearing the virtual clothing item.

9. The system of claim 8, wherein the virtual clothing item is associated with an actual clothing item.

10. The system of claim 8, wherein the identification code comprises one of a two-dimensional barcode, watermark, or serial number.

11. The system of claim 8, wherein the image comprises one of a still image, a series of still images, or a video.

12. The system of claim 8, further comprising instructions for transmitting the image to a computing device.

13. The system of claim 12, wherein the computing device is a smart phone.

14. The system of claim 8, wherein the virtual avatar is associated with a user.

15. A computer program product for simulating user clothing on a virtual avatar, the computer program product comprising a computer readable storage medium, and program instructions stored on the computer readable storage medium, to:
receive an identification code;
retrieve a virtual clothing item using the identification code; and
generate an image of the virtual avatar wearing the virtual clothing item.

16. The computer program product of claim 15, wherein the virtual clothing item is associated with an actual clothing item.

17. The computer program product of claim 15, wherein the identification code comprises one of a two-dimensional barcode, watermark, or serial number.

18. The computer program product of claim 15, wherein the image comprises one of a still image, a series of still images, or a video.

19. The computer program product of claim 15, the computer readable storage medium further comprising instructions to transmit the image to a computing device.

20. The computer program product of claim 19, wherein the computing device is a smart phone.

21. The computer program product of claim 15, wherein the virtual avatar is associated with a user.

22. A method for deploying a system for simulating user clothing on a virtual avatar, comprising:
providing a computer infrastructure being operable to:
receive an identification code;
retrieve a virtual clothing item using the identification code; and
generate an image of the virtual avatar wearing the virtual clothing item.
